(19) United States
(12) Patent Application Publication
(10) Pub. No.: US 2021/0133855 A1
(43) Pub. Date: May 6, 2021

(54) SYSTEMS AND METHODS FOR FACILITATING PRODUCT AND SERVICE FULFILLMENT

(71) Applicant: Daniel Ramirez, NEWPORT BEACH, CA (US)

(72) Inventor: Daniel Ramirez, NEWPORT BEACH, CA (US)

(21) Appl. No.: 17/089,674

(22) Filed: Nov. 4, 2020

Related U.S. Application Data
(60) Provisional application No. 62/930,451, filed on Nov. 4, 2019.

(51) Int. Cl. G06Q 30/06; G06Q 50/12; G06Q 10/08

(52) U.S. Cl. CPC G06Q 30/0633; G06Q 50/12; G06F 3/0482; G06Q 30/0643; G06Q 10/087

(57) ABSTRACT

In various embodiments, the invention teaches systems, methods, and non-transitory computer-readable media for facilitating the delivery of locally and remotely purchased goods and/or services, at a location of interest (LOI). In various embodiments, the LOI is a retail store, restaurant, bar, or the like. Various embodiments of the invention can advantageously (1) increase the possible customer base for LOIs, (2) facilitate targeted marketing for service providers, producers, and suppliers of goods and services, and (3) improve customer service.

### CROSS REFERENCE TO RELATED APPLICATION

This application claims the benefit of U.S. Provisional Patent Application No. 62/930,451 filed Nov. 4, 2019, which is incorporated by reference herein in its entirety.

### FIELD OF THE INVENTION

In various embodiments, the present invention relates to the field of electronically-driven commerce.

### BACKGROUND

The majority of the revenue in traditional retail environments, restaurants, bars and the like results from transactions initiated by customers present in those establishments at the time of purchase. In many cases, a relatively small amount of additional revenue is derived from the use of pre-purchased items, including gift cards, gift certificates, coupons and the like. There are a number of reasons why these types of pre-purchased items tend to generate a relatively small percentage of revenue for most establishments, but perhaps the most significant considerations are that the processes of pre-purchasing and/or redeeming can be inconvenient, time consuming, and sometimes embarrassing. For these reasons, most retail shops, restaurants, and bars rely heavily on a variety of well-established methods of attracting patrons who visit in-person to make purchases.

There is clearly a need in the art for methods, devices, and systems that allow for significantly expanding the customer base of restaurants, bars, retail establishments, and the like, by facilitating third party electronic purchases.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 depicts, in accordance with various embodiments of the invention, the interaction of various components of an e-commerce ecosystem described herein. Individual components of the depicted ecosystem are described in detail in the examples set forth herein.

### SUMMARY OF INVENTION

In some embodiments the invention teaches a method, including utilizing a computing device to execute a computer-executable application in order to receive an order for the purchase of one or more goods and/or services to be delivered at an LOI, wherein said computing device is utilized at said LOI. In some embodiments the one or more goods and/or services are ordered by an individual who is not located at the LOI. In some embodiments the one or more goods and/or services are ordered by an individual who is located at said LOI. In some embodiments one or more of the one or more goods are a beverage or a food.
In some embodiments the invention teaches a non-transitory computer-readable medium including computer-executable instructions that cause one or more processors of a computing device to perform steps including:
   determining one or more goods and/or services available for purchase at a location of interest (LOI), by interrogating a database;
   generating a menu of one or more goods and or services available for purchase at a LOI; and
   causing the computing device to display the one or more goods and/or services available for purchase delivery at said LOI, wherein said goods and or services are displayed in the form of text and/or images and/or video on a graphical user interface (GUI) of said computing device.
In some embodiments the invention teaches a non-transitory computer-readable medium wherein the steps performed further include communicating, directly or indirectly, the selection by a user of one or more of the goods and/or services to an electronic device operated by a service provider at an LOI.
In some embodiments the invention teaches a computer-readable medium wherein the electronic device operated by a service provider is selected from the group consisting of a smart phone; a smart watch; a tablet; an electronic device configured to emit light from one or more LED lights; a device that projects light in the form of text, pictures or symbols; and combinations thereof.
In some embodiments the invention teaches a non-transitory computer-readable medium wherein the one or more of the goods include beverages and/or foods and/or stickers and/or gifs and/or video and/or music, and the like.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

With the foregoing background considerations in mind, in various embodiments, the present application teaches methods, systems, and machine-readable media for facilitating electronic purchases in a retail environment, outdoor event, restaurant, bar, or similar setting. In some embodiments, the invention teaches distributed computer systems (e.g., cloud, mobile, wearable, and the like) working in concert to facilitate purchases at a location of interest (LOI). In the context of the present application the term “LOI” may include, but is in no way limited to, a restaurant, a bar, a retail store, an amusement park, a stadium, a concert venue, a festival venue, or any other location where goods and/or services are bought and sold, whether indoors or outdoors. In some embodiments, a location of interest is referred to herein as an establishment.

### Consumer/User Application

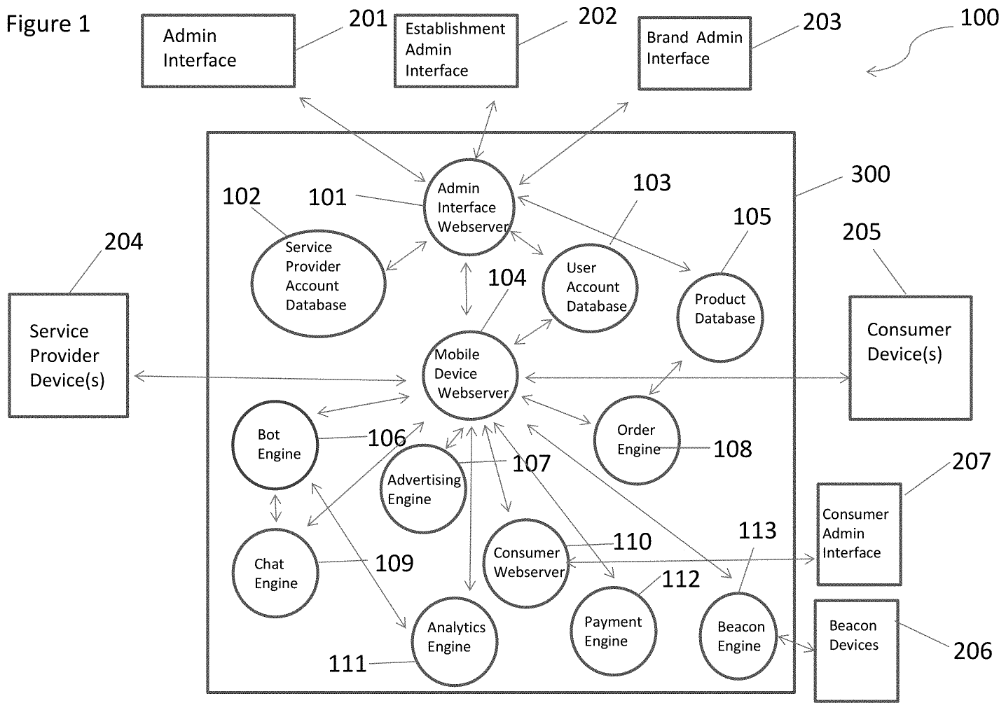

In some embodiments, the invention teaches a software application capable of running on a personal computing device, including, but in no way limited to, a phone, a computer, a smart watch (e.g., an Apple™ watch, an Android™ watch, or the like), a tablet, an earpiece configured to communicate wirelessly (i.e. electronically tethered) or through wires to any of the foregoing devices, or configured to function independently as a separate device with computing functions (the earpiece may also be configured to vibrate as a form of communication and/or accept voice commands), and the like. In some embodiments the software application is configured to allow a user to electronically communicate (e.g., through a mobile device webserver) with a personal computing device (e.g., any personal computing device described above) worn or otherwise accessible by a service provider (e.g., owner, employee, salesperson, independent contractor, and the like) working at an LOI. FIG. 1 depicts a diagram of an exemplary embodiment in which communication can take place. A complete description of this diagram is set forth in the “Examples” section. In some embodiments, the software application allows a user to select an LOI from a number of different LOIs. The software application then allows the user to view the products and/or services available at the LOI selected by the user. In some embodiments, when the user is present at the LOI, the software running on the user's electronic device communicates with a beacon located at the LOI, which then notifies the LOI of the presence of the user, and which may optionally trigger the presentment of various customized or standard promotional offers to the user through the user's device (or another user's electronic device). In some embodiments, the software running on a first user's electronic device communicates with one or more additional user's electronic device (whether the one or more additional users are present at the same location or not), alerting the one or more additional users of the first users presence at a specific location, and optionally communicating beverage preferences and/or food preferences, and/or other details of the first user's profile. In certain embodiments, the available goods and/or services are presented in the form of one or more lists. In other embodiments, the application displays photos and/or descriptions and/or names of drinks, food, or other goods or services, one page at a time, and the pages can be changed by swiping in a certain direction (e.g., up, down, left, or right). The goods or services may also be presented in form of playing cards, or any other stylistic way that conveys a theme while allowing for product or service display and subsequent selection. The software application also allows the user to select and purchase one or more goods and/or services. The application can be configured to accomplish this function in any manner of selecting through an electronic device with a graphical user interface (GUI) known in the art. Merely by way of example, through the use of one or more electrostatic sensors, pressure sensors, optical sensors (e.g. an optical sensor that is sensitive to a hand, finger, or object waving over the GUI), or combinations thereof. In some embodiments, the application also allows a user to specify one or more persons (whether situated together in a group or located in different places at an LOI) onsite at the LOI to whom the one or more goods and/or services are to be provided. In some embodiments, certain goods and/or services are recommended to the user based on information such as, but in no way limited to, previous orders delivered to the prospective recipient. In some embodiments, the application allows the user to review one or more previous orders. In some embodiments, the application allows the user to re-order a previous order. In certain embodiments, the application also allows a user to select one or more service providers of the LOI with whom the user wishes to place the order for the one or more goods and/or services. In certain embodiments, the application notifies the user about the availability and approximate wait time before services can be rendered by a particular service provider. Thus, a user may opt to wait for a particular service provider, or, if the wait is determined to be too long, the user may simply select another service provider at the same LOI.

In some embodiments, the application displays one or more characteristics (e.g., personal and/or performance characteristics) of one or more service providers of the LOI, in order to facilitate the selection by the user of one or more service provider, based on desired characteristics. In some embodiments, a picture or description of one or more service provider at a particular LOI is shown for a user to select. In some embodiments, user ratings and/or comments and/or cumulative ratings of one or more aspects of the service provider's service record are shown to a user in order to aid in the selection of an appropriate service provider. In some embodiments, two or more service providers are displayed in a list format. In certain embodiments, fewer than all of the service providers are displayed one or more at a time by the application, and a user may select the desired service provider.

In some embodiments, the user swipes up, down, left, or right to view more service providers, in a manner similar to or the same as the way in which goods and/or services are selected. In some embodiments, the application notifies the person or persons to whom the goods and/or services are to be sent that the goods and/or services have been purchased, and optionally who has purchased them. The application can be configured such that notification regarding a purchase is sent to one or more devices accessible by an owner, manager, contractor, or other worker at the LOI (e.g. a number of devices at a single location or at multiple different locations). The application can also be configured such that notification is also sent to a Brand Partner (“BP”), which in this context means a distributor or producer of one or more products and/or services sold at the LOI. When notifications of a purchase are sent to multiple users, they may be sent simultaneously or separately over a period of time. In embodiments in which multiple notifications are sent, the application may be configured to allow for selecting the order in which the notifications are sent to each recipients (which could be simultaneous), and/or to allow for sending different kinds of messages/information to one or more types of recipients based on static or dynamic rules determined by an administrator or other person with suitable administrative access. Merely by way of example, the person to whom the good or service is to be delivered may receive a message that simply indicates a product or service has been ordered and/or approximate time of arrival and/or the identity of one or more persons who purchased the good and/or service. In contrast, the application may be configured such that a BP only receives certain demographic information about the person who purchased the good or service and/or the person scheduled to receive the good or service, if one of the good or service is associated with the BP (e.g., if it is distributed and/or produced and/or promoted by the BP). This could provide valuable data to a BP regarding, for example, the efficacy of a particular marketing strategy with regard to one or more types of customers. The BP may also use the data to keep track of the redemption rate of any special coupon that it is promoting. The application could also be configured to provide notification to the owner, manager, or other staff of the LOI. The information associated with that notification could include, for example, how many goods or services have been purchased for the recipient and/or by the purchaser that day, week, month, or other timeframe, and/or what types of additional goods or services might be appropriate to promote to the recipient and/or purchaser, and/or information regarding whether the recipient or purchaser appears to have responded to a promotion. The aforementioned notifications can be made through application-to-application communication, if the recipient (e.g., any of the parties described above) also has the application, or the notification can be made through text message, email, social media platforms/applications (e.g., Facebook, What's App., Viber, Twitter, etc.) or other type of communication modality.

In certain embodiments, the application allows the customer/user and/or recipient of the goods or services and/or BP, and/or owner, manager, independent contractor, employee, etc. of the LOI to communicate with one another electronically (e.g. by an integrated chat engine, or through any known social media platform (including but not limited to any referenced herein) with which the application is configured to interface and facilitate communication). In some embodiments, the application is configured to allow the recipient to accept or request a change to an order he or she is scheduled to receive.

In some embodiments, the application uses ‘bot’ type technology to make recommendations regarding goods and/or services and/or service providers to the user that might be preferred by a prospective recipient of the goods and/or services based on the prospective recipient's ordering history and/or one or more profile characteristics of the prospective recipient and/or one or more budget requirement specified by the user. In some embodiments, the bot technology may be used to ask the user questions regarding likes and dislikes of a prospective goods and/or services recipient, or similar information, that might be useful to help make recommendations regarding goods and/or services that are likely to be well-received. In some embodiments, the application allows the user to comment on or otherwise rate the performance or attributes of the service provider and/or purchase experience.

In certain embodiments, the application indicates the current projected wait time for a particular service provider to execute a specific order. In some embodiment, the onsite recipient is selected from the user's contacts, which are accessed by the application. In certain embodiments, the application identifies which of the user's contacts are located within or near an LOI as reported by geolocation. In some embodiments, the user's contacts may further be identified by beacon technologies, such as those provided by companies such as Google, Apple, and Estimote, to name a few. In some embodiments, the application allows a user to purchase one or more goods and/or services for herself or himself at an LOI, either before arriving at the LOI, or after arriving at the LOI.

In some embodiments, the application is configured to interact with one or more proximity sensors located at an LOI. The proximity sensors communicate with the application and identify one or more individuals at the LOI that have a device running the application. A device operated by the LOI may then be used to generate special offers targeted to the consumer, either automatically, or as the result of the action of an onsite service provider who receives notification that a particular customer is present. Alternatively, or in addition, the application may be periodically updated with information about particular specials or other offers that are available at a particular location during a particular timeframe. The offers may be general offers, or they may be customized to a specific individual based on data such as order history, eligibility for frequent user rewards, etc.

In some embodiments, the application also allows an application user to notify or otherwise make known to other application users onsite or offsite that he or she is present at a particular LOI and willing or unwilling to accept goods and/or services from another user who may be located onsite or offsite. In some embodiments, the application allows for such notification, either active (e.g., in the form of a message) and/or passive (in the form of a response to request for status information) to all users of the system, select users of the system, or one or more categories of users of the system (e.g., male, female, brown-haired users, users of a certain age or having some other specific characteristic or combinations of characteristics that may be present in and ascertainable from a given application user's profile). This feature can be especially helpful in a setting that is especially busy or loud, including but in no way limited to, a bar.

For the sake of expediting purchases using the consumer/user application, in some embodiments, the application allows a user to enter details about one or more payment accounts (e.g., credit card account, checking account, savings account, and the like), so that one or more payment accounts can be selected for a particular purchase. In some embodiments, the application allows for a default setting that allows a particular payment account to be used as a default payment account unless changed by a user.

In some embodiments, the application allows for splitting a purchase between one or more consumers/customers. Thus, for example, several friends may split the cost of purchasing one or more goods or services for one or more persons, whether or not some or all of the people are executing the transaction from the same location. While this could be accomplished in many ways, in one way, the user interface may offer the option of splitting the purchase. If the consumer indicates (by selecting that option within the application) that he or she wishes to split the purchase, then the application may ask the consumer/user to indicate the person(s) with whom the purchase should be split. Once the person(s) are identified, a message can be sent (by any method of communicating described above—eg., through the application, a social media platform accessible through the application, or otherwise), to the one or more persons asking if they are willing to accept splitting the purchase, and the one or more persons can either accept or deny the request. Once the one or more persons accept the request, then the application will split the purchase, as necessary, and, as indicated above, optionally notify the recipient(s) regarding the identities of the parties who paid for the goods or services. As indicated above, the application can also be configured to allow one or more parties to select one or more recipients of one or more goods or services.

In some embodiments, the application allows a user to upload an image of his or her driver's license or other form of identification (e.g., passport, state issued identification card, etc.), so that it can be used for age verification purposes (e.g. by a service provider).

By facilitating purchases for customers located offsite from an LOI, the applications described above significantly increase the potential customer base of an LOI. In some embodiments, the application repurposes the LOI staff's normal operation in a frictionless manner to derive user information that can be used for age verification as well as creating a customized menu, marketing, and advertising communications, both inside and outside of the application. Advantageously, the application also imparts significant advantages to an offsite person, who is able to remotely purchase goods and/or services without ever entering an LOI. This could be helpful in a number of scenarios. For example, the offsite person may conveniently buy a beverage, meal, or service for a person onsite at the LOI, even though the offsite person isn't able to join the onsite person (e.g., for a celebration or otherwise). Advantageously, the application may also facilitate loyalty gifts/rewards (in any form) to patrons whose presence is more easily tracked. The application may also increase the safety of celebrity users while maintaining direct contact with their fan base.

### Service Provider Application

In some embodiments, the invention teaches a computing device (e.g., smart watch, smartphone, tablet, light projection-based notification system, wrist band capable of visual signaling (e.g. type of wristband that includes one or more lights through colored and or white light is used to signal through patterns of illumination), earpiece (wireless or wired) that can communicate with any of the aforementioned devices or that can function as a standalone device for receiving and/or sending information (e.g. with one or more of a microphone that is capable of receiving voice commands, a vibrating mechanism for providing a vibrating alert, a wireless transmitter, a receiver capable of receiving a wireless signal, and a speaker that can deliver an audio signal to a subject's ear)-executable application that allows a service provider to, among other things, receive requests for goods and/or services from a person using a consumer/user application, as described above. In some embodiments, the application and device(s) utilized by the service provider allows the service provider to respond to a request, acknowledge a request, decline a request, or otherwise communicate by a non-contact gesture (e.g., a hand wave, finger motion, etc.). In some embodiments, this is accomplished through the use of a device with one or more optical sensor, electrostatic sensor, combinations thereof, and the like, in conjunction with the inventive application. In some embodiments, when the device is a smart watch, mobile phone, or tablet, the application allows for message notification in the form of one or more sound, visual signal, physical stimulation (e.g., vibration, pulsing, heat, or other signaling). In some embodiments, the application is configured to receive a notification that a consumer/user has requested goods and/or services to be delivered to a prospective recipient onsite at the LOI, through the consumer/user application. In some embodiments, the information provided to the service provider may include one or more of the following: name of the person placing the order, name of the person receiving the order, time the order was placed, nature of the one or more goods and/or services ordered, instructions regarding preparing the one or more goods and/or executing the one or more services, instructions regarding delivering a verbal message to the prospective recipient or interacting with the prospective recipient in a specific way (e.g. wishing the prospective recipient a happy birthday, or congratulating the prospective recipient for an accomplishment, and the like), photo of the prospective recipient, age and/or gender and/or hair color and/or eye color and or other attribute of the prospective recipient, a request for a recommendation of a good and/or service for the prospective recipient, based on the prospective recipient's profile provided in the application, ordering history (short-term (e.g., from the same day) or long-term (e.g., over weeks, months, or longer)) of the consumer/user or the prospective recipient, acceptable substitute goods or services that may be provided in the event the specific goods and/or services aren't available, or aren't available within a specific time, tip provided by the consumer/user to the service provider, desired time at which the order is requested to be delivered, rating of one or more aspect of the consumer/user and/or an aggregate rating by other service providers, and an option to rate one or more aspect of the consumer/user.

In some embodiments, the application is configured to allow the service provider to split the purchase for one or more person onsite or offsite, as requested by the consumer/purchaser. Further, the application can be configured to allow a service provider (e.g. any service provider described above) to allocate a portion of a tip and/or other component of the payment to one or more service providers, BPs, etc., or to verify that one of one or more previously determined allocation formulas should be used for a given transaction. This feature can allow a service provider great flexibility in splitting a sale for the purpose of, for example, incentivizing one or more employees associated with the transaction, accounting for specials offered by a BP (which may impact how much of the revenue from a particular transaction is allocated to the BP vs. the establishment), accounting for coupons or specials offered by the establishment, etc.

In some embodiments, the application determines a suggested order in which the one or orders of a plurality of consumers/users are fulfilled. In some embodiments, the application allows the service provider to accept, modify, delay, or ignore the suggested order in which the requests are fulfilled. In certain embodiments, the application periodically offers a suggested order in which the requests are fulfilled, and said order may be accepted, modified, or ignored by the service provider. In some embodiments the suggestions are provided by the application periodically at a selectable time interval, and/or according to order volume, and/or according to time of day or night, and/or according to tip offered, or based on additional or other criteria.

In some embodiments, the application provides performance metrics and support functions for a bartender. In some embodiments, the application will provide metrics in the form of graphical and/or text dashboards and/or other formats for displaying information, to indicate one or more of the following: service rating for the service provider (any one or more of average service rating, number of service ratings, number of maximum rating, service ratings for recent orders, etc.), earnings of the service provider (by minute, hour, day, week, month, or combinations thereof), volume of orders filled and/or requested, rate of orders filled, types of orders, and the like. In some embodiments, one or more types of the aforementioned information is electronically reported and stored in a location (e.g. cloud or other database) accessible by users with permission to access said information (e.g. the owner of the LOI, a producer or distributor of the good and/or service, other service providers in the same or different LOIs (e.g.for the purposes of inspiring competition, recruiting, and the like).

In some embodiments, the application is customized to provide support functionality to assist the service provider in a specific setting. For example, the application may allow a bartender to cancel an order for a drink because the person to whom the drink is to be delivered is drunk and should not drink more. As another example, the application may allow a bartender to reject and/or suggest a modified order if a particular drink isn't available. In some embodiments, the application allows a service provider to check into or out of a particular LOI, in order to indicate his or her presence at a particular location and availability for receiving orders. This feature helps to notify users of the service provider's availability and also allows the service provider to check in and out of multiple locations where the service provider works, in the event the service provider works in multiple locations at different times.

In some embodiments, the application allows for visible branding that can be used to promote specific brands of goods, services, specials, LOIs, service providers and other items on the digital display of a computer, television with internet connectivity, smart watch, tablet, smart phone, or the like, with which the service provider interacts and receives orders. In this way, producers of products and/or services that are offered for sale using the inventive application can be promoted through the digital display with which the service provider is interacting (e.g. the face of the smart watch, screen of the television, etc.).

### Data Aggregation and Use

All of the data generated from the aforementioned embodiments of the customer/user application and service provider application can be stored on one or more cloud-based storage system or other form of data storage, as depicted in FIG. 1 and described in the “Examples” section. This allows for the collection of metrics that can be analyzed for numerous purposes (e.g., to develop dashboard analytical content). These metrics can include, but are in no way limited to customer service levels, selection of specific goods and/or services and/or combinations thereof, utilization rates, efficiency of service providers and LOIs as a whole, number and demographics of onsite users and offsite users, number and success of service providers, engagement of loyalty programs, responsiveness to promotions and specials, and the like.

All of the foregoing metrics, and various combinations thereof, allow for the development of highly-targeted marketing which could be beneficial for each of the parties in the ‘ecosystem’ (e.g. originator of good or service, provider of good or service, offsite user, onsite user, and the like). For example, the customer/user application and service provider application may be updated with specific in-application promotions that are available to customers/users and/or service providers. For example, a particular discount on a food or beverage may be offered to a user. Likewise, the sale of a specific food or beverage by a service provider could be incentivized financially (e.g. by adding to the tip) or otherwise (e.g., by increasing a service provider's rating). In addition to in-application discounts or promotions, originators (e.g., producers and/or distributors) of goods and services may also offer onsite-discounts and promotions based on trends gleaned from the aforementioned aggregated metrics. Merely by way of example, additional discounts could be offered during slow times, or in order to facilitate the sale of inventory that isn't selling well. The response to these discounts and other promotions can also be tracked, and the effectiveness of specific marketing efforts can thereby be assessed.

The data aggregated from the use of the customer/user application and service provider application may also be used in additional verticals. For example, in a bar setting, the customer/user application and/or service provider application could be configured to keep track of the number of drinks delivered to a particular onsite customer. When the number of drinks likely exceeds the limit that would induce intoxication, then the application could suggest a cab, driving service (e.g., Uber or Lift) or other service to take the person home.

### Emergency Notification

In some embodiments, the application also provides emergency information to all platform users. For example, in the case of a fire, the system could provide local, real time messaging to all users of the platform alerting them to the emergency (fire) and instructing/guiding them to the nearest exit. As another example, in the unfortunate case of domestic terror activities, the system could provide a key bi-directional emergency information link to facilitate rescue activities. The application could also provide an option for a user to indicate that he or she is safe in the event of an emergency, so that family members and others would receive notification. Additionally, a beacon within an establishment may be able to provide a list of all patrons that are located within the establishment (based on the communication between one or more beacons and patrons' electronic devices equipped with the software) to law enforcement, rescue providers, or others.

### Group Coordination Functionality

In some embodiments, the location and/or chat features of the application allow a group of individuals (2 or more) to coordinate their actions. Merely by way of example, members of a group could determine if their friends are still in an establishment to facilitate safety (find missing group members) and for ride sharing opportunities, or other activities. The application may also provide functionality that allows friends to track who they have received food or beverage orders from, including profile pictures and additional details of the people who have provided food or beverages, so that the identities of the buyers have been communicated. If a user leaves the establishment with someone who has purchased food or beverages, that purchaser's identity would have been verified by the application, and their profile/identity could optionally be shared through the application for safety purposes. The application may also allow for members of a group to chat with one another via group text. Also, when one member is planning a trip to an establishment, he or she may share her intention to revisit an establishment that was previously visited, or visit a new establishment, with a group with whom the user previously interacted.

### Establishment Support Functions

In some embodiments, the application provides performance metrics and support functions for the establishment. For example, the application will provide real time consumer utilization rates that are difficult to obtain even with on-premise management. This aggregate data can be displayed remotely to the owner, allowing them to make such real time decisions as the types of promotions offered, the frequency of loyalty rewards for patronage, and the maximization of brand (spirit) usage levels. The data can also be analyzed to determine traffic patterns and increase employee productivity, reduce time to order delivery, and increase overall customer satisfaction. The establishment may also run marketing A/B testing on offers to determine the highest revenue funnels in conjunction with brand activations. For example, the application could drive drink promotions which upsell a client from a well to brand label, or highlight a specific offering that is more lucrative to the establishment. This information may also be useful to inspire competition between two or more establishments owned by a single company or individual.

### Brand Representative Support Functions

In some embodiments, the application provides performance metrics and support functions for brand representatives (i.e. representatives a particular company associated with a brand). For example, the application will provide real time consumer utilization rates that are difficult to obtain even with account representatives. This aggregate can be displayed remotely to the brand representative, allowing them to make such real time decisions as the types of promotions offered, the frequency of loyalty rewards for patronage, and the maximization of brand (spirit) usage levels, when used in a bar or restaurant setting (or other venue in which alcoholic beverages are served). The data can also be analyzed to determine traffic patterns, increase brand awareness and utilization rates, as well as overall customer satisfaction. The brand may also run marketing A/B testing on offers to determine the highest revenue funnels in conjunction with brand activations. For example, the representative could utilize the application to purchase a round of drinks for every bar patron between the hours of 6 PM and 8 PM. With the collection of recipient analytics, the application will supply a depth of information not possible using today's on-premise shotgun marketing approaches.

### Process Notifications

In some embodiments, the application can turn novelty features of mobile hardware into business oriented process notifications generating unique color patterns to communicate with both the patrons and staff. For example, the Samsung Smart Glow led ring around the rear camera lens may be programmed to indicate drink order received, drink order processed, and drink order being served. The camera flash, led notification indicators, and other such visual, tactile, sound, and projection features could also be utilized in this manner by programming the software to control these hardware features.

### Facial Recognition

In some embodiments, the facial recognition features of mobile devices may be adapted to verify a drink recipient and enhance the systems productivity and payment methods increasing the establishment's efficiency and accuracy. Furthermore, the facial recognition of such devices as a Google Glass and a Microsoft HoloLens can provide real time recognition within the wearable device. This extends the application's aforementioned use of a mobile device to display customer photos (on a mobile device, tablet, or non VR/AR/MR wearable) in enhancing the order processing by assisting the staff in recognizing the drink recipient which is especially useful in crowded environments. In some embodiments, facial recognition features may be adapted to verify human user profiles and provide opportunities to share real facial images to necessary platform users like bartenders, while allowing more entertaining imagery to be displayed to friends and strangers, thereby maximizing privacy and safety as well as establishment serving efficiency.

### Application in Large Venues

In some embodiments the application can be utilized in large venues (stadiums, fairs, concerts) to assist the order/delivery mechanisms. For example, a stadium vendor could be summoned from a mobile device (whether acting as a beacon or otherwise direct messaging) to a consumer, process their order, and deliver without having to walk all the aisles. With season ticket holders, this process could be augmented with bots to automate regular orders and even upsell the consumer based on the application's cloud stored loyalty information. Another example could envision a beer or t-shirt vendor processing orders at a concert venue, reducing the lines, increasing efficiency, and utilizing analytic feedback to better target inventory levels and consumer product reception.

### Cloudless Communication

In some embodiments, the application can induce sharing directly (locally) between consumers' mobile/wearable devices without relying on the cloud. For example, device to device communication protocols can be utilized to share a drink order to a friend, which, once accepted, could then be relayed to the cloud. In some embodiments, the application could utilize graphical representations only (emojis, stickers, etc.) which could further increase the fun while also increasing the consumer acceptance and efficiency. In some embodiments, a customized emoji or picture of bartender could be selected, followed by an emoji or picture of a friend reported to be at an establishment, followed by an emoji associated with a particular drink. This information could be sent to a service provider at the establishment, who could then optionally respond with an emoji indicating the order has been received and/or processed (e.g. a thumb up).

### Blockchain Interface

In some embodiments, the application can store and relay information via blockchain protocols. The information can be fungible (interchangeable, divisible), available for conversion such as tokens, coins, or monetary equivalents, or non-fungible (unique, not divisible), available for use as collectibles. The fungible tokens may be utilized in mechanisms such as, but not limited to, direct payment of one or more crypto currencies (bitcoin, ether, and the like), loyalty rewards earned for consumer behaviors, or non-monetary virtual currencies used in gaming mechanics to facilitate and drive user behavior. By way of example, signed memorabilia can be tracked and given away at a LOI to consumers. The blockchain capabilities can also store platform analytic data ensuring marketplace compliance and audit data, firewalling establishment and brand data, as well as securing sensitive customer data.

### Consumer Admin Interface

In some embodiments, the application can relay information to the consumer via a consumer admin interface. For example, consumer admin interface 207 as depicted in FIG. 1 and integrated within environment 300 could be used. By using the consumer admin interface, the consumer can set up and edit their account information such as name, address, email, gender, age, photo, avatar, and phone number. In some embodiments, the application can also relay statistical information such as favorite drink, bars frequented, and list of purchases and receipts.

Various embodiments of the present invention are described in the ensuing examples. The examples are intended to be illustrative and in no way restrictive.

### EXAMPLES

### Example 1

### Functionality and Architecture

FIG. 1 depicts cloud platform ecosystem 100 (all components of figure), which includes platform server software 300. The cloud platform ecosystem 100 includes administrative interface web server 101, which is in electronic communication with global administrative interface 201, Location of interest (LOI) administrative interface 202, and brand administrative interface 203. The global administrative interface 201 regulates the entire platform depicted in FIG. 1. The global administrative interface 201 can be used as a master administrative console to monitor and control all aspects of the platform, cloud, and its associated devices. The administrative interface webserver 101 and global administrative interface 201 facilitate onboarding new establishments/(LOIs) and regulating their use of the platform. As new establishments are added, the administrative console 201 will act as an “air traffic controller,” monitoring establishment patron levels, drink orders and efficiencies, product offerings, advertising flow, analytics, and the like while creating multiple dashboards to monitor the respective areas. In some embodiments, this will be accomplished by interacting with various databases (patrons, bartenders, item catalogues catalogs, and the like) and engines (analytics, bot, advertising, and the like) to orchestrate the ecosystem depicted in FIG. 1 and described herein. The administrative interface 201 will interface with the brand administrative interface 203 to monitor, process, and regulate actions for brand content such as orders (e.g. alcohol product orders in a bar environment), brand placements, brand events, and the like. The administrative interface 201 interacts with the LOI/establishment administrative interface 202 to facilitate the monitoring, modifying, and regulating actions for the LOI. For example, it can facilitate providing super-user access to the establishment(s) for customer service needs, device type updates (e.g., tablet, wearables, and the like), utilization rates, on-premise activities, and the like. FIG. 1 shows an administrative interface webserver 101 in electronic communication with service provider (e.g. bartender, server, etc.) database 102, which includes account information (e.g., profile information, service ratings, order fulfillment history, efficiency, etc.) for service providers who have registered through a service provider application. Administrative interface webserver 101 is also in electronic communication with user account database 103, which includes information about consumers/users, including consumer/user profiles, preferences, order histories, ratings, and other events and facts associated with the consumers/users of the application. User account database 103 and bartender account database 102 both receive information from and send information to mobile webserver 104, which in turn communicates electronically (sends information to and receives information from) service provider device 204 and user device 205 to accomplish the methods described herein. Administrative interface webserver 101 is also in electronic communication with product (e.g. beverage) database 105, which is in turn in electronic communication with order engine 108. Chat engine 106, bot engine 107, advertising engine 110, analytics engine 109, consumer webserver 111, and payment engine 112 are also depicted. Chat engine 106 facilitates chatting between two or more parties selected from consumers/users, prospective recipients, service providers, goods and/or services producers, administrators, and others interacting through the ecosystem described herein. The bot engine 107 performs the bot-associated tasks described herein, including recommending various courses of action to one or members of the ‘ecosystem’ based on mining the data of transactions within the ecosystem. The advertising engine 110 allows advertisers to include messaging to users and/or bartenders/establishments interacting in the ecosystem described herein. The analytics engine 109 is configured to allow for analysis of one or more components of the data aggregated in the ecosystem as a result of the transactions described herein. The payment engine 109 facilitates payments for the goods and services provided, and allows for storage of individual payment account information, as described above. The consumer admin interface 207 can be configured to allow users to examine/modify their accounts via the web. The consumer device(s) 205 will have analogous functionality and will interact with the consumer admin interface 207 through their respective webservers, 110 and 104 for congruity. The consumer admin interface 207 will facilitate/allow editing of user profile information (name, age, phone number, photo, and the like) and examination of dashboards reporting last purchase information (e.g., one or more of LOI, friend name, drink order, drink price, and the like) as well as access of information from the brand or establishment (specials, brand information, and the like). The consumer admin interface may be supported by advertising, especially video content pertinent to the brand, establishment, and the like. For instance, sponsored photos of the receiving party at the LOI may be viewed here.

Beacon engine 113 facilitates location of individuals within or in close proximity to one or more establishments by detecting a signal generated by the individuals' one or more electronic devices. As such, the beacon engine also facilitates the location of individuals outside the boundaries of said establishments (ie off-premise). In certain embodiments, the consumer's mobile application can be enabled to generate a signal that allows for location by a beacon engine. In some embodiments, the beacon engine 113 will communicate with one or more beacon devices of a consumer/patron as well as one or more beacon devices of a service provider. The beacon devices can include any wireless device capable of producing a wireless signal that can be associated with a specific location, either by integration with mapping technology (e.g. Google maps), or by triangulation determined by multiple additional electronic devices that communicate with the beacon device. The beacon devices described herein may ‘announce’ the location of the devices with coordinates associated with a map, or by communicating with a permanent beacon present within a service provider's establishment, and associated with that address. In addition, consumer devices may act as individual transient beacon devices thereby sharing location information without requiring a permanent beacon presence. In this example, when a patron enters a service provider's establishment, the software application running on the consumer's electronic device communicates with a beacon of the establishment. The consumer's electronic device may also communicate the identity/type of the consumer to the beacon engine, which can in turn communicate with additional users of the software (e.g. other consumers or service providers) through additional electronic devices capable of receiving a signal. In this way, service providers may manually or automatically generate customized offers and send them to a consumer's electronic device when the consumer enters an establishment, remains in range of a set/subset of beacons, or is outside the range of aforementioned beacons. In addition, other consumers may be made aware that a particular consumer or type of consumer has entered the establishment, remains within an area of the establishment, or is outside (off-premise) the establishment. This feature may be especially desirable for facilitating social gatherings and social/mobile interactions among friends, or meetings between people conducting business, including those who have never met before. In this way, customers may offer establishment services to each other using social cues such as instant messages, stickers, and the like. The admin interfaces 201, 202, and 203 may also access the beacon engine to determine consumer and establishment usage levels in conjunction with the analytics engine 111. In this way, an establishment may determine which brand offerings resonate with the consumers and update offerings in real-time or the bot engine 106 may make specific recommendations to facilitate and spur desired consumer activity.

### Example 2

### Application Functionality in Bar Setting

The user/consumer downloads, installs, and opens the consumer/user application on his smart device. The application synchronizes contacts within the user's smart device to determine who his friends are. The application determines which friends are located within a participating LOI using geolocation techniques. The user chooses which friend he would like to purchase a drink for. The application is then used to choose (e.g. by swiping or scrolling) a drink from a menu of beverage options available at the LOI where his friend is located. The application also enters his credit card information that is securely stored for the purchase. The user then reviews his order and confirms his purchase. The application sends the order to the cloud while optionally requesting a tip for the bartender and a rating for the experience. The user then immediately receives a digital receipt. The friend for whom the drink was ordered (“receiving friend”) receives a notification that he has received a beverage from a friend, the user. The notification comes in the form of an in-application notification on the receiving friend's smart device. If the receiving friend doesn't currently have the application installed on his smart device, this notification can be relayed via SMS/MMS, or similar methods. The receiving friend then must confirm with the establishment waitstaff of the drink order by showing his ID and application message. This step not only confirms his order, but also follows establishment protocols by confirming the age (21 for adult beverages) of the receiving friend.

The bartender of the LOI receives a notification that a drink has been ordered for one of his patrons. This notification may be received in several ways, but let's start with the simplest, the bartender's smart phone. The bartender will have a separate bartender application. The application will receive order notifications from the user for the bartender to fulfill. The bartender will process the order like he would a normal drink. Since the drink has been paid for already by the user, no point of sale system (POS) integration is required, making the application POS agnostic. This is a significant competitive advantage allowing the bartender to fulfill the transaction as he would with a normal on-location transaction (unobtrusive value proposition). The application's geolocation will confirm the receiving friend is at the LOI. The receiving friend's action of presenting his ID for the “gifted” drink will also confirm his presence and ability to receive the drink. The drink is then delivered from the bartender to the receiving friend and the transaction is completed at the register. The transaction is entered as a tender associated with the application. This type of transaction is standard operating procedure for all establishments in processing gift cards, discounts, and the like. Thus, this is a seamless and standard process. The bartender can then process the next drink order.

What is claimed is:

1. A method, comprising: utilizing a computing device to execute a computer-executable application in order to purchase one or more goods and/or services from a service provider at a location of interest (LOI), wherein the goods and/or services are to be rendered at said LOI.

2. The method of claim 1, wherein said goods and/or services are ordered for delivery onsite at the LOI.

3. The method of claim 1, wherein the one or more goods and/or services are ordered for delivery to one or more individuals other than an individual utilizing the computer-executable application for placing an order for the one or more goods and/or services.

4. The method of claim 1, wherein the one or more goods and/or services are ordered for delivery to the same individual as the individual utilizing the computer-executable application for placing an order for one or more goods and/or services.

5. The method of claim 1, wherein the one or more goods comprise beverages or foods.

6. The method of claim 5, wherein the service provider is a waiter or bartender.

7. A method, comprising: utilizing a computing device to execute a computer-executable application in order to receive an order for the purchase of one or more goods and/or services to be delivered at an LOI, wherein said computing device is utilized at said LOI.

8. The method of claim 7, wherein the one or more goods and/or services are ordered by an individual who is not located at the LOI.

9. The method of claim 7, wherein the one or more goods and/or services are ordered by an individual who is located at said LOI.

10. Wherein one or more of the one or more goods are a beverage or a food.

11. A non-transitory computer-readable medium comprising computer-executable instructions that cause one or more processors of a computing device to perform steps comprising:
determining one or more goods and/or services available for purchase at a location of interest (LOI), by interrogating a database;
generating a menu of one or more goods and or services available for purchase at a LOI; and
causing the computing device to display the one or more goods and/or services available for purchase delivery at said LOI, wherein said goods and or services are displayed in the form of text and/or images and/or video on a graphical user interface (GUI) of said computing device.

12. The non-transitory computer-readable medium of claim 11, wherein the steps performed further comprise communicating, directly or indirectly, the selection by a user of one or more of the goods and/or services to an electronic device operated by a service provider at an LOI.

13. The non-transitory computer-readable medium of claim 12, wherein the electronic device operated by a service provider is selected from the group consisting of a smart phone; a smart watch; a tablet; an electronic device configured to emit light from one or more LED lights; a device that projects light in the form of text, pictures or symbols; and combinations thereof.

14. The non-transitory computer-readable medium of claim 11, wherein the one or more of the goods comprise beverages and/or foods and/or stickers and/or gifs and/or video and/or music, and the like.
